(19) United States
(12) Patent Application Publication
(10) Pub. No.: US 2008/0167922 A1
(43) Pub. Date: Jul. 10, 2008

(54) Regulatory compliancy tool

(75) Inventors: Eduard Paul Noorloos, Bleiswijk (NL); Bert Schijf, Voorburg (NL); Ron Hartman, Amersfoort (NL); Erik Stibbe, The Hague (NL)

Correspondence Address: MICHAELSON & ASSOCIATES, P.O. BOX 8489, RED BANK, NJ, 07701-8489, US

(73) Assignee: KONINKLIJKE KPN N.V., The Hague (NL)

(21) Appl. No.: 12/002,353

(22) Filed: Dec. 17, 2007

Related U.S. Application Data
(60) Provisional application No. 60/875,142, filed on Dec. 15, 2006.

(51) Int. Cl. G06Q 10/00

(52) U.S. Cl. 705/7

(57) ABSTRACT

A computer-based system and method for evaluating effectiveness of internal controls of an entity's financial statement, the method utilizing a set of evaluation criteria and a hierarchical structure comprising at least a top level, an intermediate level, and a component level. The top level comprises items corresponding to items in the financial statement, the intermediate level comprises one or more sub-items corresponding to each item of the top level, and the component level comprises one or more components corresponding to each sub-item of the intermediate level. One or more risks are defined for each component, and ratings for each risk and each component are determined against at least a portion of the evaluation criteria. The ratings from the component level are consolidated to generate proposed ratings at the intermediate level, and the ratings from the intermediate level are consolidated to generate proposed ratings at the top level.

### CROSS-REFERENCE TO RELATED APPLICATIONS

This application claims priority from U.S. provisional application Ser. No. 60/875,142 filed on Dec. 15, 2006, the contents of which are hereby incorporated by reference in their entirety.

### BACKGROUND OF THE INVENTION

1. Field of the Invention

The invention relates to systems and methods for monitoring compliance with regulatory requirements. In particular, the invention relates to a computer-aided system and method for monitoring compliance with the Sarbanes Oxley financial reporting requirements.

2. Description of the Related Art

The PCAOB (Public Company Accounting Oversight Board) requires that the management of a public company assess the effectiveness of the internal controls used by the company over its financial reporting, i.e., the company's financial statements. The PCAOB has published auditing standards for audits of a company's internal control over its financial reporting, as required by Section 404(b) of the Sarbanes-Oxley Act of 2002.

This internal audit requires financial data to be collected for the relevant period and the risk evaluated as to whether there are material inaccuracies of the data. Existing tools permit the registration of risks, control measures, and deficiencies, and base the evaluation mainly on the impact of the deficiencies.

The Sarbanes-Oxley Act requires that top management of a publicly traded company to sign off on the company's financial reports. Thus, the results of the internal audit of the effectiveness of internal controls must be conveyed to and made comprehensible to the top management, although they may not have been directly involved in the audit. In a large company with many divisions and subdivisions, the management at different levels may not have been directly involved in the audit at lower levels of the organization.

### BRIEF SUMMARY OF THE INVENTION

The present invention seeks to address these problems by providing a computer-implemented system and method for evaluating effectiveness of internal controls of an entity's financial statement. The system and method utilize a set of evaluation criteria and a hierarchical structure comprising at least a top level, an intermediate level, and a component level. The top level comprises items corresponding to items in the financial statement, the intermediate level comprises one or more sub-items corresponding to each item of the top level, and the component level comprises one or more components corresponding to each sub-item of the intermediate level. One or more risks are defined for each component, and ratings for each risk and each component are determined against at least a portion of the evaluation criteria.

Financial data is assigned to the components. The ratings and financial data from the component level are consolidated to generate ratings and financial data for the intermediate level, the consolidated ratings from the component level being provided as proposed ratings at the intermediate level. The ratings and financial data from the intermediate level are consolidated to generate ratings and financial data for the top level, the consolidated ratings from the intermediate level being provided as proposed ratings at the top level.

The ratings preferably comprise an evaluation of okay or not okay against each relevant evaluation criteria, and the ratings criteria preferably comprise the CAVECOD criteria. The ratings for each risk defined for a component are preferably provided as proposed ratings which can be accepted or rejected for the component, and the consolidation of ratings from a lower level to a higher level comprises providing a proposed rating of not okay at the higher level if any of the corresponding ratings at the lower level are not okay. The proposed ratings at a level may be overridden by a user with an authorization to override ratings at the level. The assigning of financial data to the components includes importing or entering financial data, defining covered amounts for the data, and assigning the covered amounts to the components.

Another aspect of the invention comprises a computer-based system for evaluating the effectiveness of internal controls of an entity's financial statement. The system utilizes a set of evaluation criteria and a hierarchical structure comprising at least a top level, an intermediate level, and a component level. The system comprises a top level schedule comprising line items corresponding to line items in the financial statement, with financial data and ratings for each line item, an intermediate level schedule comprising one or more sub-items corresponding to the line items of the top level, with financial data and ratings for each sub-item, and a component level schedule comprising one or more components corresponding to each sub-item of the intermediate level, with financial data and ratings for each component.

A risk ratings document is provided for entering ratings against at least a portion of the evaluation criteria for a set of predefined risks, and a component ratings document for entering ratings against at least a portion of the evaluation criteria for a predefined set of components. The system includes a module for consolidating the ratings and financial data from the component level to generate ratings and financial data for the intermediate level, the consolidated ratings from the component level being provided as proposed ratings at the intermediate level, and for consolidating the ratings and financial data from the intermediate level to generate ratings and financial data for the top level, the consolidated ratings from the intermediate level being provided as proposed ratings at the top level.

The schedules preferably display the ratings using an indication for okay or not okay against each relevant evaluation criteria, preferably the CAVECOD criteria. The module preferably consolidates ratings from a lower level to a higher level by providing a proposed rating of not okay at the higher level if any of the corresponding ratings at the lower level are not okay, and permits the proposed ratings at a level to be overridden by a user with an authorization to override ratings at the level.

Displays are preferably provided for assigning financial data to the components and defining covered amounts for the data, and an evaluation database is provided for storing the financial data and ratings. The system preferably requires a user to have an authorization to access or make modifications to the evaluation database, the authorization permitting access or modifications for one or more levels in the hierarchy of the system.

The compliancy tool of the invention provides an effective means to assess the effectiveness of the internal controls used by a company over its financial reporting. The tool generates an evaluation directly related to the line items in the company's financial statements, and the evaluation ends with an “in control” conclusion per line item of the financial statements, using assertions mentioned in the auditing standards. This approach yields a evaluation tool that is comprehensible for top management of a company, who are not directly involved in the evaluation of risks, control measures, and deficiencies.

The tool provides a hierarchical structure where conclusions at lower levels within the organizational structure are consolidated to generate proposed conclusions at higher levels. Users can navigate up and down the evaluation framework within the tool and see the evaluation conclusions per line item of all underlying organizational levels, preferably graphically represented by a check mark or a cross.

### BRIEF DESCRIPTION-OF THE DRAWINGS

The features and advantages of the invention will be appreciated upon reference to the following drawings, in which:

FIG. 1 is an example of a top level consolidated schedule generated by the tool according to an embodiment of the invention;

FIG. 2 is an example of a lower level schedule for a particular line item from the schedule of FIG. 1;

FIG. 3 is an example of a still lower level schedule for a particular sub-item from the schedule of FIG. 2;

FIG. 4 is flowchart showing steps for generating the consolidated schedule of FIG. 1;

FIG. 5 is an example of a display for rating evaluation operating effectiveness for a risk;

FIG. 6 is an example of a display for rating evaluation operating effectiveness for a component;

FIG. 7 is an example of a display for requesting closing of a reporting entity document; and

FIG. 8 is an example of a display for closing of the current evaluation period.

### DESCRIPTION OF ILLUSTRATIVE EMBODIMENTS

The following is a description of an embodiment of the invention, given by way of example only and with reference to the drawings. The embodiment of the compliancy tool described herein is designed to support compliance with Section 404 of the Sarbanes-Oxley Act, although the tool could be adapted for use for compliancy with other regulatory or reporting, e.g., ISO9000.

The tool registers risks, control measures, and deficiencies, and provides facilities to assign risks to components, assign components to line items, create control measures and link them to risks, link deficiencies to risks and improvement actions, the improvement action containing information on how the deficiency can be alleviated. The tool consolidates conclusions for components, leading to an overall conclusion per line item of the financial statements. The evaluation is directly related to the line items in the company's financial statements, leading to an “in control” conclusion per line item of the financial statements, using assertions mentioned in the auditing standards. This approach results in an evaluation tool that is comprehensible for the top management of a company, who are not directly involved in the evaluation of risks, control measures, and deficiencies.

The tool provides a hierarchical structure where conclusions at lower levels within the organizational structure are consolidated to generate proposed conclusions at higher levels. Users can navigate up and down the evaluation framework within the tool and see the evaluation conclusions per line item of all underlying organizational levels, preferably graphically represented by a check mark or a cross. Access to the evaluation data is safeguarded by an elaborate set of access profiles. The tool has an interface for actuals per line item and supports the registration of amounts covered.

The compliancy tool supports an evaluation per line item by proposing conclusions based on the conclusions established in the tool one or more organizational level lower. When a negative conclusion is overruled, the tool requires a reason and provides facilities for documenting the reason within the tool.

The tool supports the creation and use of so-called chains, using control measures performed in one organizational entity to offset a risk in another reporting entity, where applicable. The tool calculates the sample size for testing, using parameters entered by the user. Users with the appropriate authorizations can execute reorganizations of the internal control framework by copying and/or moving parts of the internal control framework from one organizational entity to another. The user can choose to delete the evaluation conclusions of the old organization. The tool also provides for automatic archiving per time-frame, e.g., per quarter, and provides extensive support of filing scanned documents in the tool.

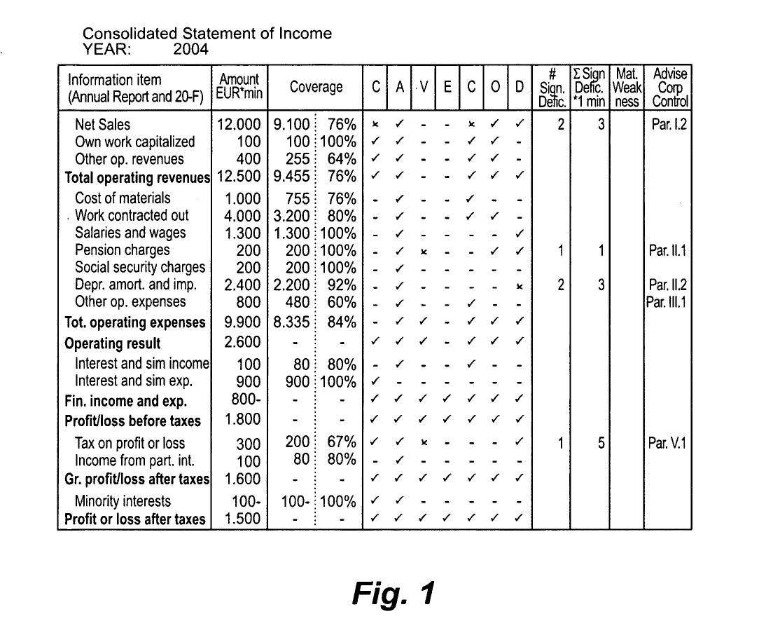

Referring to FIG. 1, an example of a top level consolidated schedule is shown that can be generated and displayed for a Company for a particular Evaluation Period by the tool of the invention. This schedule shows the results for the Consolidated Statement of Income, but the same type of schedule could also be generated for a Balance Sheet or other type of financial or other regulatory, compliance, or reporting statement. In the example shown in FIG. 1, a top level overview is shown which summarizes the reporting information for the Company.

The first two columns (“Information item” and “Amount”) show a list of line items and reported amounts for each item. The line items will usually match items and amounts reported by the Company in a financial, regulatory, or compliance report, e.g., an Annual Report, Form 20-F, or similar report. The third column (“Coverage”) represents the proportion of the reported amounts for each line item that originate from processes which have internal controls that have been evaluated and tested. These internal control measures to mitigate potential risks in the financial or other data used as inputs. For example, a potential risk for net sales data may be that the sales recorded in the company's billing system was too high. An example of a control measure would be to cross check the billing system numbers with the general ledger. This control could be evaluated and tested by examining how the cross check was performed and confirming that it has been done. The tool preferably provides facilities for documenting the test in a test report which has been coupled to a control measure, and result of testing the operating effectiveness of a control measure is set out in a test report. The tool also preferably calculates the sample size for testing, using parameters entered by the user regarding the frequency of confirmation and importance/type of confirmation.

The coverage may be represented as an amount and as a percentage. In the example shown in FIG. 1, the first information item “Net Sales” has a reported amount of 12,000 million euros and coverage of 76% or 9,100 million euros. This indicates that of the 9,100 million euros reported for that item is reported using processes that have been evaluated and tested. Lowered coverage may occur, e.g., where some revenue streams are too small for detailed reporting, which reduces coverage of reported total revenue. For each line item the risk profile and the required coverage will be determined and entered in a dedicated table in the tool. When the coverage meets the required level, this is indicated in the schedule of FIG. 1, for example by displaying the coverage percentage in green, and otherwise in red.

In the fourth column, each line item is scored against the “CAVECOD” criteria. CAVECOD is an acronym for the evaluation criteria: Completeness (C), Accuracy (A), Valuation (V), Existence (E), Cut off (C), Obligation & rights (O), and Disclosures (D). Completeness refers to whether the reported amounts are complete. Accuracy takes into account how reliable the reported amounts are, e.g., whether they are based on an estimate or hard data. Valuation takes into account valuation risks, e.g., the risk inherent in items dependent on estimates of value. Existence refers to doubts about existence of something. Cut off refers to risks caused by a cut-off, e.g., where financial reporting is made according to a certain accounting period. Obligation & rights refers to, e.g., guarantees to customers, claims against the Company, etc. Disclosures refers to risk created when previous disclosures or statements are different from a current statement.

The scores for each line item against the CAVECOD criteria are preferably represented as “okay” (e.g., using a check mark symbol) or “not okay” (e.g., using a cross symbol). It is also preferred to avoid using question marks for the end evaluation of FIG. 1. Thus, in the overview schedule, a question mark (which may have been generated at a lower level) is preferably scored as not okay. Note that not all CAVECOD criteria are relevant for each information item. When not applicable, a symbol (e.g., a dash) is displayed to indicate that a particular CAVECOD criteria is not relevant for an item, and no scoring is performed for that criteria relative to that item.

If a line item includes a score of “not okay” for any CAVECOD criteria, this represents a significant deficiency. An analysis of the impact of the deficiency is made, resulting in an estimate of the risk, expressed in euros for example. The fifth column of the overview schedule of FIG. 1 shows the number of significant deficiencies for each item, and the sixth column shows the estimated risk attributable to those deficiencies. The seventh column provides an indication of whether the deficiency constitutes a Material Weakness that needs to be reported, for example to the Board of Directors and/or shareholders of the company. The eighth column provides a reference, and preferably a hyperlink, to a textual explanation or comment regarding the deficiency. The explanations/comments are preferably documented within the compliancy tool. It should be noted that these conclusions and amounts can only be filled in by persons with a sufficient authorization.

An overall evaluation and advice regarding the overall conclusion is preferably prepared as a separate report apart from the tool, the report referring in the consolidated schedule and to the related textual explanation or comments in the tool. Alternatively, the report could be generated within the tool itself.

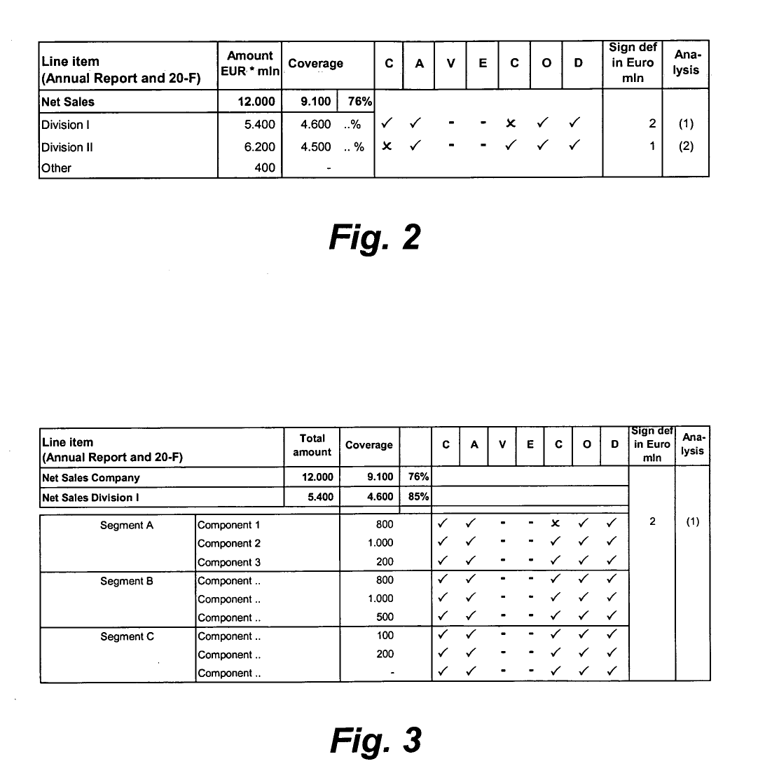

FIG. 2 shows a more detailed evaluation for a particular line item that can be generated and displayed by the tool. The schedule of FIG. 2 could be accessed by clicking on a particular line item of the top level consolidated schedule shown in FIG. 1, in order to display a more detailed breakdown of sub-items making up the line item.

In the example shown in FIG. 2, the line item “Net Sales” has a reported total amount of 12,000 million euros. Each division generating sales is shown as a sub-item. The total sales amount is broken down to show net sales amounts for each division, and the coverage amount and percentage is also shown for each division. Scores against the CAVECOD criteria are shown for the reported amounts for each division. These scores are consolidated in the top level schedule shown in FIG. 1, so that any “not okay” scores in any sub-item generate a “not okay” score in the corresponding consolidated item. In the example shown in FIGS. 1 and 2, net sales for Division I has a “not okay” score against criteria C (cut off), and net sales for Division II has a “not okay” score against criteria C (completeness). This results in the net sales item in the consolidated schedule shown in FIG. 1 having a “not okay” score against criteria C (completeness) and C (cut off).

The second-to-last column of FIG. 2 shows the estimated risk attributable to the deficiencies for each sub-item, and these risks are totaled and shown against the line item on the consolidated schedule of FIG. 1. The overall conclusion in the example of FIGS. 1 and 2 is that total risk for the 12,000 million euro net sales amount reported is estimated at 3 million euro. The last column provides a reference, and preferably a hyperlink, to a textual explanation or comment regarding the deficiency, which preferably is documented within the compliancy tool. The estimate of the impact of a “not okay” could be prepared by personnel in the Company's Division/Segment Control or by Corporate Control. A conclusion is formulated, which can be prepared by Division/Segment Control or Corporate Control, but is more likely a role for Corporate Control.

FIG. 3 shows a still more detailed view with a breakdown for a particular sub-item, which could be accessed by clicking on the sub-item in the schedule of FIG. 2. In the example shown in FIG. 3, a breakdown is shown for the sub-item Division I net sales. The schedule in FIG. 3 shows the amount and coverage for the line item Net Sales (12,000 and 9,100), and for the sub-item Division I (5,400 and 4,600). Division I is further broken down into Segments with subcategories named “Components.” A component may be defined as a part of a line item which is subject to its own risks and/or control measures. For example, the sub-item Division I net sales could consist of three components that correspond to three different products of the company that have different reporting risks associated with them. A risk is the description of the possibility that a component in a material sense is unreliable. Risk is specific for one component but one component can contain several risks.

Control measures are necessary in order to cover risks. Since one control measure can cover several risks these to be defined separately in the tool and later linked to the risks which the control measure covers. The links of a control measure to a risk may be done by means of a related control measure. The control measure is fixed and is tested at the level of the Reporting Entity which carries out the control measure. The Reporting Entity is preferably defined as the highest level in the hierarchy for the import of financial data. Reporting Entities may exist at different levels within the hierarchy of the tool, for example at the Component level, Segment level or Division level in the example shown in the drawings.

In the example shown in FIG. 3, the covered amount is shown for each component. Scores against the CAVECOD criteria are shown for each component, as well as the estimated risk attributable to any deficiencies for each component, and a reference (and preferably a hyperlink) to a textual explanation or comment regarding the deficiency. The scores and risk estimates are consolidated in the schedules shown in FIG. 2 and then FIG. 1, so that any “not okay” scores for any component will be reflected for the corresponding sub-item in FIG. 2 and item in FIG. 1. The estimated risks are similarly consolidated into the schedules of FIGS. 2 and 1. In the example shown, the schedule of FIG. 3 shows that the risk in Division I comes from Component 1 of Segment A.

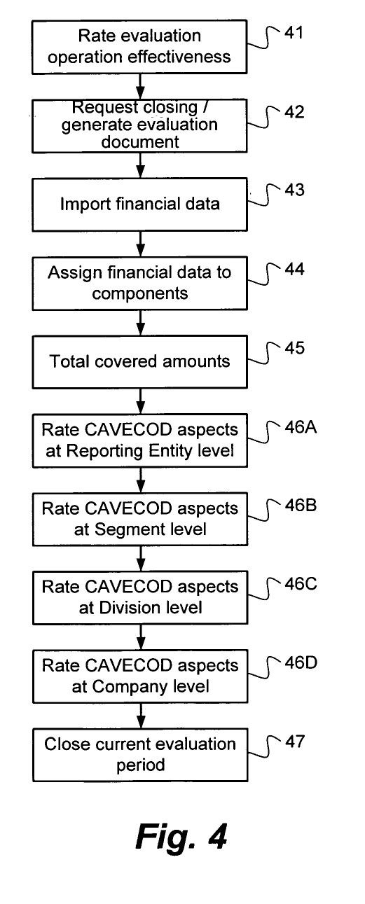

Data is entered into the Evaluation Database of the compliancy tool for a particular Evaluation Period. The evaluation preferably starts at the end of a specified period (e.g., a quarter) when all internal financial control related actions have been completed. FIG. 4 shows a flowchart of the steps that can be performed to generate the consolidated schedule as in the example shown in FIG. 1. It should be noted that the order of the steps is not fixed and they can be performed in a different order.

Step 41 of FIG. 4 is rating of the “Evaluation Operating Effectiveness” for risks, components, and control measures in the tool. For each risk and control measure it is indicated which CAVECOD criteria are applicable, and for a ‘related’ control measure it is indicated which CAVECOD criteria are covered by the control measure for a risk. For example, CAVECOD criteria C, A and O may apply to Risk 1, CAVECOD criteria C, A, V and E may apply to Risk 2, and control measure 1 may cover CAVECOD criteria C, A, V, E, C and O. The CAVECOD criteria which do not apply for a specific risk are preferably ‘turned off’ in the related control measure. In the example, for risk 1 the criteria V, E and C must be turned off, and for risk 2 the criteria C and O must be turned off.

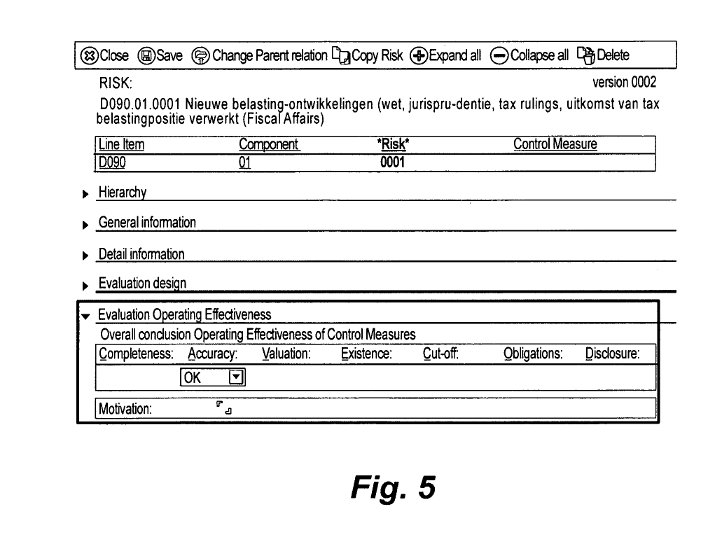

The rating is performed for risks before components. FIG. 5 shows an example of a display for rating evaluation operating effectiveness for a risk. The risk to be rated is opened for editing in the tool, and “Evaluation Operating Effectiveness” is selected as shown in the display shown in FIG. 5. The appropriate values are entered. In the example shown in FIG. 5, this includes rating the Accuracy aspect as okay or not okay. The document is saved and this procedure is repeated for the other risks.

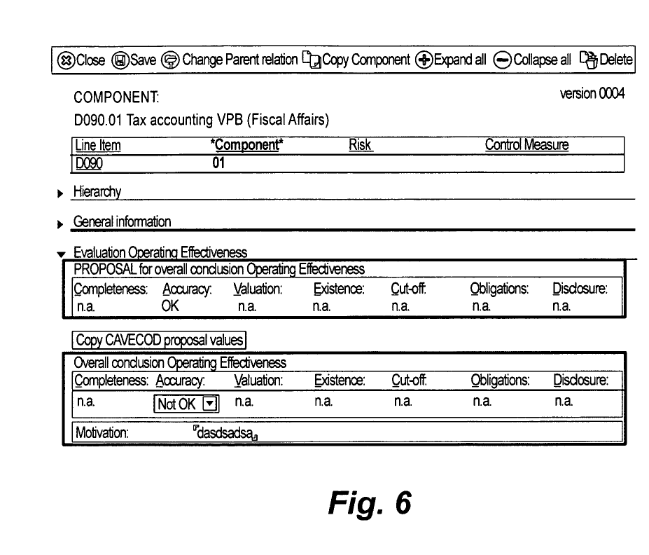

FIG. 6 shows an example of a display for rating evaluation operating effectiveness for a component. The component to be rated is opened for editing in the tool, and ‘Evaluation Operating Effectiveness’ is selected as shown in the display of FIG. 6. Two sets of fields are displayed, one set with the ‘Proposal’ rating (based on the evaluation operating effectiveness from all associated risks) and one set for the ‘Overall conclusion’ for the component. The appropriate values are entered. The action ‘Copy CAVECOD proposal values’ can be used to copy the values from the proposal to the ‘Overall conclusion’. The document is saved and this procedure is repeated for the other components. The CAVECOD criteria are now rated on risk and component level.

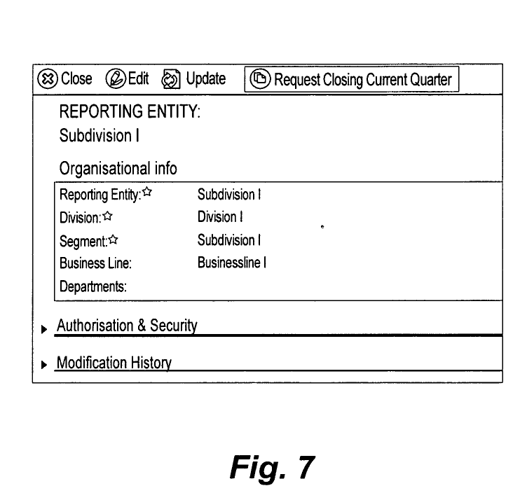

When the necessary documents have been rated, the ‘Request closing’ action shown in step 42 of FIG. 4 can be activated to request the closing of the current quarter (or other evaluation period) for Reporting Entities. Preferably this action can only be triggered by the ‘CFO’ role of the Reporting Entity. The procedure to request closing can preferably be provided in the tool, for example by selecting a Reporting Entity document, opening the document, and clicking on the ‘Request Closing Current Quarter’ button. FIG. 7 shows an example of a display for requesting closing of a Reporting Entity document. The closing triggers generation of the Evaluation documents, which can occur e.g., during nighttime. The request closing is repeated for other Reporting Entities as needed. When this has been completed, all of the evaluation documents have been created in the evaluation database.

In step 43 of FIG. 4, financial data is imported from data sources external to the evaluation database of the tool. Alternatively financial data can be entered into the evaluation database directly via the tool. The financial data is assigned to the components in step 44 of FIG. 4, and the covered amounts (i.e., the amounts in the ‘Coverage’ column in the schedule shown in FIG. 3) are totaled in step 45.

In steps 46A to 46D of FIG. 4, the CAVECOD criteria are rated at each level. Rating starts at the lowest level and proceeds to each higher level. The Component level has already been rated in step 41. The rating then proceeds, for example, at Segment level, Division level, and finally Company level. Preferably, rating on a level can be done if the lower level is completely rated. Other levels and/or a different number of levels could be used, depending on the size and structure of the company. The CFO or other assigned person at each level is preferably responsible for rating of the CAVECOD criteria for that level.

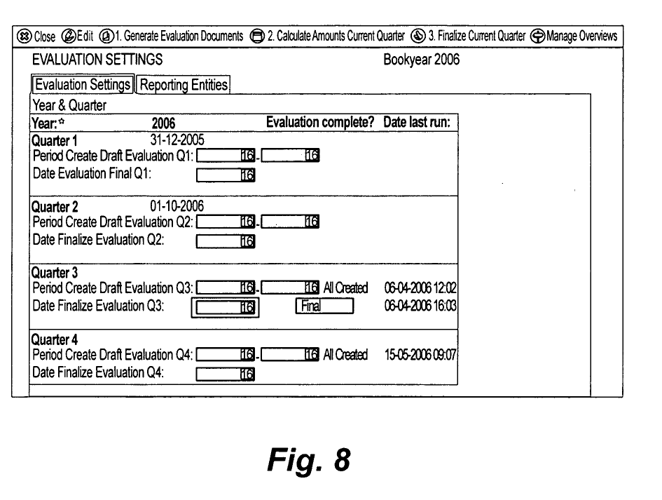

When all CAVECOD criteria are filled and all financial data has been divided, the current Evaluation Period can be closed, as shown in step 47 of FIG. 4. Preferably the closing of the Evaluation Period can only be performed: when all CAVECOD criteria of all evaluation documents are filled in; on the specific date set in the tool; and when it has not already been closed. FIG. 8 shows an example of an ‘Evaluation Settings’ document including a ‘Date Evaluation Final’ field per quarter for entry of the specific date for closing, and including a status field for indicating a ‘Final’ status when the Evaluation Period has been closed. If not all above-mentioned requirements are met, the tool will preferably prevent the closing of the current Evaluation Period.

When closing the current evaluation quarter one or more of the following actions are performed by the tool: all evaluation documents are given the status Final and cannot be modified anymore; all evaluation overviews are generated; the divide financial data indication for each line item in the tool is reset; all the Request documents from the reporting entities to generate evaluation documents are deleted; and the ‘Processed’ indication for Reporting Entities is removed. These actions are preferably performed automatically by the tool in the background, and some of the actions may be performed overnight. This completes one (quarterly) evaluation cycle for the company.

Different processes are defined to guarantee the reliability of the tool, for example change management and security management processes. Risks and control measures are also defined in the tool for these processes, known as General Computer Controls. The result of testing the operating effectiveness of a GCC is provided in a GCC test report. At certain point in the evaluation process there may be an incompleteness with regard to set-up and functioning of the tool and/or GCCs. These incompletenesses are defined as a deficiency, and improvement action may be linked to the deficiency. The improvement action contains information on how the deficiency can be alleviated.

Before users can start working with the Evaluation Database of the tool, several configuration settings have to be implemented, preferably by the Application Manager or similar role authorized in the tool to perform this function. At the beginning of each Evaluation Period, the setup configuration is preferably checked and/or completed. One or more of the following steps can be performed:

Set the fields to define the Evaluation Period, e.g., the year and quarter;

Define the hierarchy, e.g., the Divisions, Segments, Components, and the authorized ‘Dividers Actuals’ for each Reporting Entity;

Setup the preferred Line Items which will appear in the top level end evaluation;

Set the preferred Reporting Entities;

Set the period for creating draft evaluations;

Create or check the authorizations for all levels and fill in the CFO name(s); and

Create or check the mapping of accounts to line items.

Several roles can be defined for an Evaluation Database, each with certain rights and permitted actions. A user is assigned one (or more) of the defined roles in order to perform actions in the database. These defined roles can be, for example:

Sox Manager, who rates the CAVECOD criteria at the Component level in the database of the tool;

Reporting Entity CFO (Chief Financial Officer), who activates or requests generation of Evaluation documents and who decides on final CAVECOD ratings at the Reporting Entity level;

Dividers Actuals, who divide financial data at the Component level in the database of the tool;

Segment CFO, who decides on final CAVECOD ratings at the Segment level and can change lower level documents;

Division CFO, who decides on final CAVECOD ratings at the Division level and can change lower level documents;

Company CFO, who decides on final CAVECOD ratings at the Company level and can change lower level documents;

Company Audit, who has access to view all (final) documents;

Company CC (Corporate Control), who has access to view all documents and edit draft documents;

Application Manager, who can configure the settings of the evaluation database; and

Data File Manager, who does the configuration and import of financial data.

The invention has been described by reference to certain embodiments discussed above. It will be recognized that these embodiments are susceptible to various modifications and alternative forms well known to those of skill in the art without departing from the spirit and scope of the invention. Accordingly, although specific embodiments have been described, these are examples only and are not limiting upon the scope of the invention, which is defined in the accompanying claims.

What is claimed is:

1. A computer-based method for evaluating effectiveness of internal controls of an entity's financial statement, the method utilizing a set of evaluation criteria and a hierarchical structure comprising at least a top level, an intermediate level, and a component level, the method comprising:
defining the top level comprising line items corresponding to line items in the financial statement;
defining the intermediate level comprising one or more sub-items corresponding to the line items of the top level;
defining the component level comprising one or more components corresponding to each sub-item of the intermediate level;
defining one or more risks for each component;
entering ratings for each risk against at least a portion of the evaluation criteria;
entering ratings for each component against at least a portion of the evaluation criteria;
assigning financial data to the components;
consolidating the ratings and financial data from the component level to generate ratings and financial data for the intermediate level, the consolidated ratings from the component level being provided as proposed ratings at the intermediate level; and
consolidating the ratings and financial data from the intermediate level to generate ratings and financial data for the top level, the consolidated ratings from the intermediate level being provided as proposed ratings at the top level.

2. The method of claim 1, wherein the ratings comprise an evaluation of okay or not okay against each relevant evaluation criteria.

3. The method of claim 2, wherein the ratings criteria comprise the CAVECOD criteria.

4. The method of claim 1, wherein the ratings for each risk defined for a component are provided as proposed ratings which can be accepted or rejected for the component.

5. The method of claim 1, wherein the steps of consolidating ratings from a lower level to a higher level comprises providing a proposed rating of not okay at the higher level if any of the corresponding ratings at the lower level are not okay.

6. The method of claim 1, wherein the proposed ratings at a level may be overridden by a user with an authorization to override ratings at the level.

7. The method of claim 1, wherein the step of assigning financial data to the components comprises importing or entering financial data, defining covered amounts for the data, and assigning the covered amounts to the components.

8. A computer-based system for evaluating effectiveness of internal controls of an entity's financial statement, the system utilizing a set of evaluation criteria and a hierarchical structure comprising at least a top level, an intermediate level, and a component level, the system comprising:
a top level schedule comprising line items corresponding to line items in the financial statement, with financial data and ratings for each line item;
an intermediate level schedule comprising one or more sub-items corresponding to the line items of the top level, with financial data and ratings for each sub-item;
a component level schedule comprising one or more components corresponding to each sub-item of the intermediate level, with financial data and ratings for each component;
a risk ratings document for entering ratings against at least a portion of the evaluation criteria for a set of predefined risks;
a component ratings document for entering ratings against at least a portion of the evaluation criteria for a predefined set of components; and
a module for consolidating the ratings and financial data from the component level to generate ratings and financial data for the intermediate level, the consolidated ratings from the component level being provided as proposed ratings at the intermediate level, and for consolidating the ratings and financial data from the intermediate level to generate ratings and financial data for the top level, the consolidated ratings from the intermediate level being provided as proposed ratings at the top level.

9. The system of claim 8, wherein the schedules display the ratings using an indication for okay or not okay against each relevant evaluation criteria.

10. The system of claim 9, wherein the schedules display ratings of CAVECOD criteria.

11. The system of claim 8, wherein the module consolidates ratings from a lower level to a higher level by providing a proposed rating of not okay at the higher level if any of the corresponding ratings at the lower level are not okay.

12. The system of claim 8, wherein the module permits the proposed ratings at a level to be overridden by a user with an authorization to override ratings at the level.

13. The system of claim 8, comprising displays for assigning financial data to the components and defining covered amounts for the data.

14. The system of claim 8, comprising an evaluation database for storing the financial data and ratings.

15. The system of claim 14, wherein the system requires a user to have an authorization to access or make modifications to the evaluation database, the authorization permitting access or modifications for one or more levels in the hierarchy of the system.
